(19) United States
(12) Patent Application Publication
(10) Pub. No.: US 2006/0131325 A1
(43) Pub. Date: Jun. 22, 2006

(54) Cooling system for alcohol beverage dispensing apparatus

(76) Inventors: Albert Wauters, Destelbergen (BE); Hans Donker, Eindhoven (NL); Ian Anderson, Burwell (GB); Edward P. Duffy, Royston (GB); Andrew R. B. Halket, Cherry Hinton (GB)

Correspondence Address: James W Kerr;Interbrew SA, 303 Richmond Street, London, ON, N6B 2H8, CA

(21) Appl. No.: 10/536,973

(22) PCT Filed: Nov. 25, 2003
(86) PCT No.: PCT/IB03/05403

§ 371 Date: Dec. 23, 2005

(30) Foreign Application Priority Data
Nov. 29, 2002 (GB) 0227923.0
Nov. 29, 2002 (GB) 0227926.3

(51) Int. Cl. B67D 5/08

(52) U.S. Cl. 222/54

(57) ABSTRACT

A beer or like alcohol beverage dispensing apparatus has a keg for containing the beverage. A keg dispensing device is connected through a top portion of the keg and extends to a bottom portion of the keg to draw the beverage from the keg adjacent the bottom portion. The apparatus has a cooling plate in heat transfer contacting relation with the bottom of the keg and also has a Peltier thermoelectric device connected to the cooling plate so as to extract heat from the cooling plate and thereby extract heat from the keg. The cooling apparatus has a first temperature sensor, mounted in heat sensing relation with a bottom portion of the keg and a second temperature sensor mounted in heat sensing relation with an upper portion of the keg. A controller controls the cooling apparatus in response to the first and second temperature sensors so as to control the operation of the cooling apparatus to extract heat from the bottom portion of the keg to lower and maintain the temperature of the beverage contained in the keg to a desired beverage serving temperature. The keg may comprise either steel, stainless steel or copper so as to provide a stratified cooling effect or may comprise aluminum so as to initially cool the beverage in the container in a more homogeneous manner.

### FIELD OF THE INVENTION

The present invention relates to a cooling system for use in an alcohol beverage dispensing apparatus and in particular, relates to a cooling system having temperature control that maintains a beer beverage at a desired serving temperature.

### BACKGROUND OF THE INVENTION

Beer dispensing apparatus are known in the art for dispensing of draft beer in taverns and the like. Typically, the beer is chilled prior to being dispensed by passing through a conical run of tube that passes through a chilled compartment containing ice and water. In some instances the compartment is refrigerated. Such draft beer dispensers are utilized in taverns where the large volumes of beer are dispensed everyday and the taverns have room to store such chillers. This is not the case for a domestic or home beer dispensing apparatus that is adapted to sit on a countertop in a kitchen where space is at a premium.

Further, due to limited countertop space requirements, there still is a need to chill or cool the beer in the dispensing apparatus to desired serving temperatures and to maintain the beer in the dispenser at the desired serving temperature.

This presents a problem when a user wishes to obtain a serving of beer from the dispenser prior to the beer contained within the keg reaching a suitably cold serving temperature.

This problem associated with an initial serving prior to the beer contents of the keg being cooled to a suitable serving temperature is compounded further by different consumer preferences where consumers may wish to have an initial serving of one glass of beverage or multiple glasses such as two servings of the beverage.

There is a need to provide cooling systems that accommodates a consumer who desires to have one initial serving of beverage prior to the beer or beverage in the keg reaching it's serving temperature or, alternatively, for a consumer who desires to have multiple servings of the beverage prior to the beverage reaching it's desired serving temperature.

### SUMMARY OF THE INVENTION

It is an object of the present invention to provide an alcohol dispensing apparatus that maintains the beer in the apparatus at a desired serving temperature wherein, once the beverage in the keg is cooled to the desired serving temperature, multiple servings of the beverage in a short time period may be dispensed with each serving being dispensed substantially at the same desired serving temperature for the beverage.

It is a further object of the present invention to provide a beer or the like alcohol beverage dispensing system having a cooling apparatus that cools the beverage in a manner to provide an initial serving that is relatively cold compared the beverage remaining in the keg after the initial serving and prior to the beverage reaching a desired serving temperature.

It is a second object of the present invention to provide a beer or the like alcoholic beverage dispensing system having a cooling apparatus that uniformly cools the beverage so that two servings of beverage may be drawn at substantially the same temperature prior to the beverage reaching its desired serving temperature.

The present invention relates to a cooling apparatus for cooling a keg containing an alcohol beverage which is preferably beer. The cooling apparatus has a first temperature sensor mounted in heat sensing relation with a bottom portion of the keg to sense first temperatures related to temperature of the beverage at the bottom portion of the keg and a second temperature sensor mounted in heat sensing relation with an upper portion of the keg to sense second temperatures related to temperature of the beverage at the upper portion of the keg. The cooling apparatus includes a cooling controller responsive to the first and second temperature sensors for controlling operation of the cooling apparatus to extract heat from the bottom portion of the keg to lower and maintain temperature of the beverage contained in the keg at a desired beverage serving temperature.

Preferably, the cooling apparatus operates to extract heat form the keg when either one, or both, of the first and second temperature sensors sense temperature below the desired beverage serving temperature. The controller cycles the cooling apparatus off when both the first and second temperature sensors sense temperature indicative of the beverage being at its desired beverage serving temperature. The controller cycles the cooling apparatus off when the first temperature sensor senses temperature associated with the beverage freezing.

In accordance with one aspect of the present invention there is provided a beer or like alcohol beverage dispensing apparatus comprising a keg containing beer or like alcohol beverage and having a bottom portion and an upper portion remote from the bottom portion. The dispensing apparatus has a keg dispensing device extending into the keg to the bottom portion to draw the beverage from the keg adjacent the bottom portion. The dispensing apparatus has a cooling apparatus in heat transfer contacting relation with the keg for extracting heat from the beverage contained in the keg through the bottom portion of the keg to thereby cool the beverage. The cooling apparatus comprises a first temperature sensor mounted in heat sensing relation with a bottom portion of the keg to sense first temperatures related to temperature of the beverage at the bottom portion of the keg and a second temperature sensor mounted in heat sensing relation with an upper portion of the keg to sense second temperatures related to temperature of the beverage at the upper portion of the keg. The cooling apparatus includes a cooling controller responsive to the first and second temperature sensors for controlling operation of the cooling apparatus to extract heat from the bottom portion of the keg to lower and maintain temperature of the beverage contained in the keg at a desired beverage serving temperature.

In accordance with a further aspect of the present invention there is provided a beer or like alcohol beverage dispensing apparatus comprising a keg containing beer or like alcohol beverage and having a bottom portion. The apparatus has a keg dispensing device extending into the keg to the bottom portion to draw the beverage from the keg adjacent the bottom portion. The apparatus has a cooling apparatus in heat transfer contacting relation with the bottom portion of the keg for cooling the beverage contained in the keg through the bottom portion. The keg comprises a material selected from the group consisting of steel, stainless steel and copper that initially cools the beverage in the keg upwards from the bottom portion of the keg to produce a stratified beverage temperature effect whereby, prior to all the beverage in the keg reaching a desired serving temperature, the beverage adjacent the bottom portion of the keg is the coolest beverage available for an initial serving.

In accordance with yet a further aspect of the present invention, there is provided a beer or like alcohol beverage dispensing apparatus comprising a keg containing beer or like alcohol beverage and having a bottom portion. The dispensing apparatus has a keg dispensing device extending into the keg to the bottom portion to draw the beverage from the keg adjacent the bottom portion. The dispensing apparatus has a cooling apparatus in heat transfer contacting relation with the bottom portion of the keg for cooling the beverage contained in the keg through the bottom portion. The keg comprises an aluminum material that initially cools the beverage in the container in a substantially homogeneous manner above the bottom portion of the keg whereby two servings of beverage dispensed from the keg are at substantially the same temperature prior to the beverage reaching a desired serving temperature.

### BRIEF DESCRIPTION OF THE DRAWINGS

For a better understanding of the nature and objects of the present invention reference may be had to the accompanying diagrammatic drawings in which:

FIG. 1 is a front elevation view of a home beer dispensing apparatus in accordance with the present invention;

FIG. 2 is a side elevation view of the home beer dispensing apparatus; and,

FIG. 3 is a side sectional view of the keg shown inside the beer dispensing apparatus of FIG. 2 having a dispensing spear within the keg and a cooling system for cooling the contents of the keg.

### DETAILED DESCRIPTION OF THE INVENTION

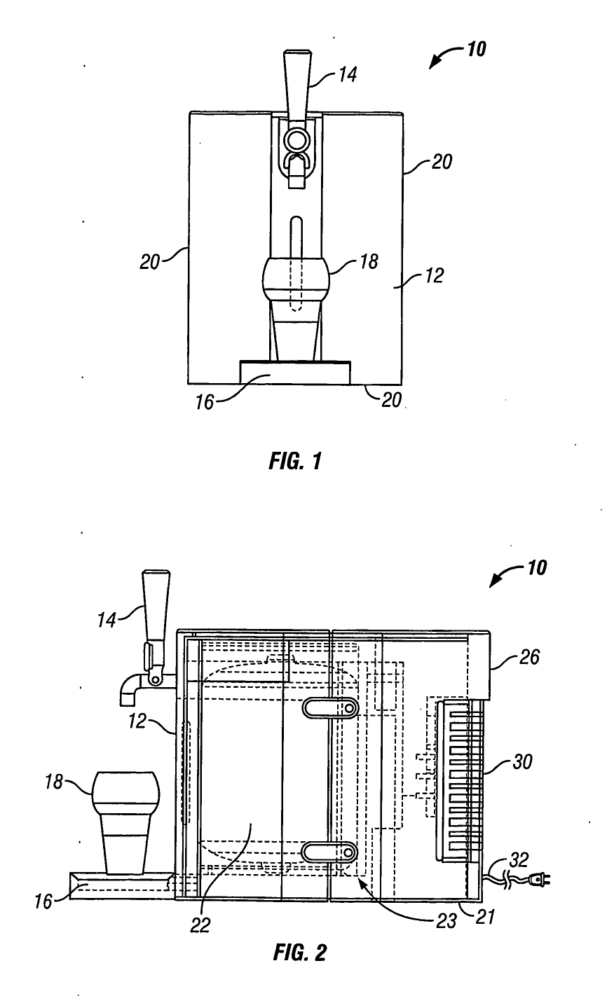

Referring to FIGS. 1 and 2 there is shown a home beer dispensing apparatus, appliance or unit 10. The dispensing apparatus 10 is primarily intended for use in domestic kitchens but may also be used in utility rooms, garages, domestic bars, caravans etc. While the preferred embodiment relates to dispensing beer, alternatively carbonated solutions or other alcohol beverages may be dispensed by apparatus 10.

The home beer dispensing apparatus 10 has a front wall 12 and a dispensing tap 14 protruding forward of the front wall 12. A drip tray 16 also protrudes forward of the front wall 12 and is adapted to support an open glass container 18 below the dispensing tap 14. The home beer dispensing apparatus 10 further has a base 21 adapted to rest on a counter top in a kitchen. The front wall 12 is formed as an extension of two pivoting side walls 20 which may be moved between closed and open positions to allow the keg 22 (see FIG. 2 in broken lines) to be inserted into the housing of the home beer dispensing apparatus 10. The housing of the home beer dispensing apparatus 10 further includes a top wall 24 and a rear wall 26. The rear wall 26 has a grill 30 that permits for air circulation within the home beer dispensing apparatus 10. An electrical cord 32 extends through the rear wall 26 of the apparatus 10 to provide a connection into a main electrical supply to supply electrical power to the electrical components housed within the dispensing apparatus 10. Alternatively, a 12 Volt DC supply input may be used.

The dispensing apparatus 10 has a cooling system 23 located behind and below keg 22 that is adapted to cool the keg 22 of beer when placed in dispensing apparatus 10. The dispensing apparatus 10 also dispenses the beer by providing a pressurised air supply (not shown).

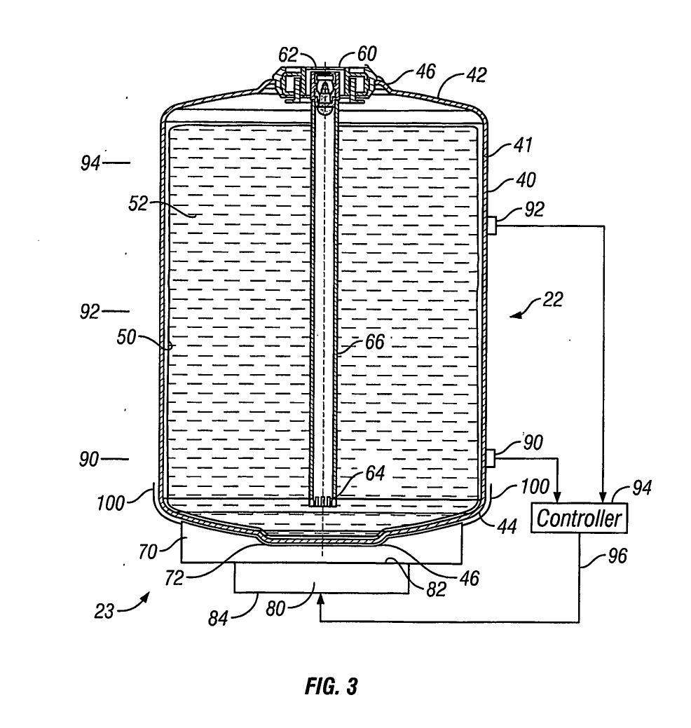

Referring to FIG. 3, the keg 22 of the present invention is shown in more detail. The keg 22 has a general cylindrical shape with side walls 40 and a top wall or top portion 42 and a bottom wall or bottom portion 44. Both top wall 42 and bottom wall 44 are curved upwardly from the central portion of the keg 22 and are provided at both top and bottom portions 42 and 44 or hoop and girder with a raised annular collar 46. The collars 46 provide additional support for the keg 22. Mounted within the keg walls 40, 42 and 44 is a plastic bag 50 for containing alcohol beverage, which in the preferred embodiment is, beer 52.

As shown in FIG. 3, the keg is filled completely with beer 52 within the bag 50 and as a result the bag 50 lines the inside walls of the keg 22. As the beer 52 is dispensed from the keg 22, an air pressure is established between the walls of the bag 50 and the inside surfaces of walls 40, 42 and 44 of the keg so as to provide pressure to the bag allowing the beer 52 to be dispensed from the keg 22.

The top portion 42 and collar 46 located in the top portion 42 of keg 22 has a keg dispensing device or valve 60 extending through the top collar 46. The keg dispensing device 60 is connected to the tap 14 of the beer dispensing apparatus 10 by a tube connection (not shown) extending from the keg dispensing device 60 at its top end 62. The dispensing device 60 has a hollow spear 66 that extends into the keg 22 within bag 50 so as to provide a remote opened end 64 adjacent the bottom portion 44 of the keg for drawing beer 52 from the keg adjacent the bottom portion 44 of the keg 22. Beer 52 is drawn through opening 64, up hollow spear 66 out through end 62 to the tap 14 (FIG. 1).

The cooling of the keg 22 within the beer dispensing apparatus 10 is accomplished by a cooling apparatus 23 comprising cooling plate 70 having a cooling surface 72 that in the preferred embodiment is in mechanical and heat transfer contacting relation with the bottom portion of the keg 22 for extracting heat from the beer 52. The bottom portion of the keg may be adapted by, for example being profited, to match that of cooling surface 52.

The cooling apparatus further includes a Peltier thermoelectric device 80 mounted in mechanical and thermal heat transfer contacting relation with the cooling plate 70. The Peltier thermoelectric device 80 is connected through a suitable leads and transformer (not shown) to the power supply line or cord 32 (see FIG. 2) so that a voltage is applied across the Peltier thermoelectric device 80. The voltage drop across this Peltier cooling device 80 results in a thermal difference being generated across the device whereby surface 82 of Peltier device 80 is cooler than hot surface 84. As a consequence, heat is extracted from the cooling plate 70 which in turn extracts heat from the keg 22. The Peltier thermoelectric device 80 provides a low rate of continuous cooling.

As a result of the Peltier cooling device 80 acting through cooling plate 70 to extract heat from the beer 52 within the bottom portion 44 of the keg 22, a stratification effect occurs in the initial cooling of the beer prior to the beer reaching its desired serving temperature. That is to say, that the beer contained in the lower portion of the keg has a tendency to be colder than the beer contained in the upper portions of the keg. This stratification effect also occurs naturally with warmer beer tending to rise to the top of the bag 50 in keg 22. Also the selection of keg material may effect the stratification layers formed by temperature differences in the beer. A keg 22 selected from materials such as stainless steel and steel have greater inherent stratification effects than a keg selected from aluminum. The stratification effect of the temperature of the beer 52 becomes less of a problem once all the beer 52 is cooled to a suitable serving temperature.

In accordance with the present invention, the material selection for the keg 22 in conjunction with the cooling apparatus 23 comprising cooling plate 70 and Peltier thermoelectric device 80 may be chosen to provide the consumer with an initial serving of the beverage or beer 52 at it's coldest temperature possible prior to the contents or the entire beverage beer 52 reaching a desired serving temperature.

For this aspect, the keg 22 is selected from either steel or stainless steel material to provide a stratified cooling of the beer 52 within the keg 22. This stratified cooling is shown by horizontal lines 90, 92 and 94 representing cooler temperatures of the beer 52 within the keg 22 as the distance of the beer 52 from the bottom portion 44 of the keg increases. This is due in part to the location of the cooling plate being at the bottom portion 44 of the keg 22 and in part to the heat transfer relation of the steel or stainless steel from the bottom wall portion 44 up the side walls 40. In other words, when steel or stainless steel is used for keg 22, heat extracted from the beer occurs through the keg bottom portion 42 at a faster rate than heat extracted from the beer 52 through the side walls 40 of keg 22. This produces a stratification effect in temperature and results in an initial beverage serving from the tap 14 drawing on beer 52 that is adjacent the bottom portion 44 of the keg 22 being the coldest beer available. It should be understood however that a second serving immediately following the first serving will probably not be as cold as the first serving until such time as the temperature of the beer 52 within keg 22 has reached its desired serving temperature.

In accordance with another aspect of the present invention the keg may comprise aluminum mounted with the cooling plates 70 and the Peltier thermoelectric device 80 for the cooling apparatus. In this embodiment, the beer 52 will be cooled in a more even or homogeneous manner such that the stratification effect shown by lines 90, 92 and 94 is non-existent. As a result, the temperature of the beer 52 in the keg 22 will be lowered substantially homogeneously to the desired serving temperature. This homogenous cooling is believed to be the result of the aluminum being able to extract heat from side walls 40 of keg 22 at a rate to create turbulence or mixing of the beer in the keg 22. Consequently, multiple servings of beer 52 may be made through tap 14 which will be at a more uniform temperature prior to the beer 52 reaching its desired serving temperature.

In an alternate construction, the cooling plate 70 may be provided with flange or annular flange 100 which extends partially up the side walls 40 of the keg 22 so as to insure for a more homogenous cooling rate of the beer 52 within the aluminum keg 22.

It should also be noted that the home beer dispensing apparatus 10 may have insulation provided in its front wall 12, side walls 20, rear wall 26 and top wall 24. The insulation is provided to insulate the keg 22 from the surrounding environment of the apparatus 10 so that the beer 52 is maintained at a cooler temperature while conserving on the energy used to operate on the Peltier device 80. It is also envisaged that the insulation in the side walls and top walls of the apparatus 10 may be graduated. That is the insulation may be thicker or more effective towards the bottom portion 44 of the keg 22 and considerable less effective towards the upper portion 42 of the keg 22. This enhances the stratification effect of the keg 22.

It is further envisaged that the material used for the stratification effect may include copper, however, the cost of the copper may make its use somewhat prohibitive in this application.

However, the Peltier thermoelectric device must be controlled in a manner that does not result in the temperature of the beer freezing. If the beer 52 freezes adjacent the open end 64 of the spear 66, clearly, it will be difficult or even not possible to dispense beer from the keg 22.

In another aspect, the present invention further provides a sensor system comprising a first temperature sensor 90 which is positioned to sense the temperature of the keg outer wall 40 adjacent the lower portion 44. It should be understood that the sensor 90 may be placed at any suitable location against the keg and is supported within the home beer dispensing apparatus 10. The sensor 90 could alternatively be located on the bottom wall portion 44 of the keg 22. The purpose of sensor 90 is to sense temperatures associated with the temperature of the beer 52 contained in or adjacent the bottom portion 44 of the keg 22. The temperature sensor 90 provides a signal indicative of sensed temperature to controller 94 which is supported within the apparatus 10. Controller 94 may comprise any suitable electronic controller including a CPU. The controller 94 in response to having a temperature sensed by sensor 90 that corresponds to the temperature at which the beer 52 freezes adjacent the bottom portion 44, sends a signal along line 96 to the Peltier cooler 80 to de-energize or result in the Peltier cooler 80 cycling into an off or lower cooling condition. It should be understood that the Peltier cooler 80 by its very nature in effect has a continuous current flow through it, however, the signal line 96 may reduce this current so that the cooling effect on the beer 52 at the bottom portion 44 of the keg is reduced significantly thereby prevents beer 52 from freezing.

The present invention provides a second temperature sensor 92 located supported in apparatus 10 to be mounted adjacent or heat sensing relation with an upper portion 41 of the keg 22. In FIG. 3, the second temperature sensor 92 is illustrated to contacts the side wall 40 of the keg 22 above the center line of the keg. It should be noted that for the purposes of the present invention, the sensors 90 and 92 must be spaced sufficiently far enough apart in order for the sensors to provide adequate readings of the temperatures associated with beer at the top portion 41 and the bottom portion 44 of the keg 22.

While the preferred embodiment and throughout the specification and claims reference is made to two temperature sensors, it should be understood that multiple sensors such as three or four temperature sensors may be provided in order to provide different temperature readings for the beer in the keg 22.

The purpose of the second temperature sensor 92 is to sense temperatures of the beer 52 at locations within the keg 22 remote from where the heat is being extracted from the keg 22. This provides an adequate temperature sensing within the apparatus 10 that monitors the stratification effect of temperature variations of the beer 52 for beer that is located further away from the cooling plate 70.

The temperature sensor 92 sends a signal indicative of the temperature of the beer 52 adjacent the upper portion 41 of the keg 22 to controller 94. When this signal indicates that beer 52 adjacent the upper portion 41 has reached the desired serving temperature of the beer 52, the controller 94 de-energizes cooling plate 70. The signal from temperature sensor 92 overrides any signal provided form temperature sensor 90 associated with the beer 52 located adjacent the lower portion 44 indicating that the beer 52 in the bottom portion 44 of keg 22 has reached its desired serving temperature from having controller 94 de-energize cooling plate 70. However, once both sensors 90 and 92 provide an indication to controller 94 that the beer 52 within the keg 22 has reached a desired serving temperature the controller 94 reduces the extraction of heat through the cooling plate 70 so as to maintain the temperature of the beer 52 contained within the keg 22 at its desired serving temperature. It should be understood that the first temperature sensor 90 may be sensing temperatures below the desired beverage serving temperature while the second temperature sensor 94 is sensing temperatures above the desired beverage serving temperature as the beer temperature profile in the keg 22 follows a hysteresis loop profile due to the stratification effect. As long as the bottom sensor 90 does not sense a temperature associated with the freezing temperature of beer, the beer in keg 22 is cooled until sensor 92 generates a signal indicative of the beer in the upper portion of the keg has reached the desired beverage serving temperature.

What is claimed is:

1. A beer or like alcohol beverage dispensing apparatus comprising:
a keg containing beer or like alcohol beverage and having a bottom portion and an upper portion remote from the bottom portion;
a keg dispensing device extending into the keg to the bottom portion to draw the beverage from the keg adjacent the bottom portion;
a cooling apparatus in heat transfer contacting relation with the keg for extracting heat from the beverage contained in the keg through the bottom portion of the keg to thereby cool the beverage, the cooling apparatus comprising:
a first temperature sensor mounted in heat sensing relation with a bottom portion of the keg to sense first temperatures related to temperature of the beverage at the bottom portion of the keg;
a second temperature sensor mounted in heat sensing relation with an upper portion of the keg to sense second temperatures related to temperature of the beverage at the upper portion of the keg; and,
a cooling controller responsive to the first and second temperature sensors for controlling operation of the cooling apparatus to extract heat from the bottom portion of the keg to lower and maintain temperature of the beverage contained in the keg at a desired beverage serving temperature.

2. The apparatus of claim 1 wherein the controller cycles the cooling apparatus on when either one, or both, of the first and second temperature sensors sense temperature above the desired beverage serving temperature.

3. The apparatus of claim 1 wherein the controller cycles the cooling apparatus off when the both the first and second temperature sensors sense temperature indicative of the beverage being at its desired beverage serving temperature.

4. The apparatus of claim 1 wherein the controller cycles the cooling apparatus off when the first temperature sensor senses temperature associated with the beverage freezing.

5. The apparatus of claim 2 wherein the controller cycles the cooling apparatus off when the first temperature sensor senses temperature associated with the beverage freezing.

6. The apparatus of claim 2 wherein the controller cycles the cooling apparatus off when the both the first and second temperature sensors sense temperature indicative of the beverage being at its desired beverage serving temperature.

7. The apparatus of claim 6 wherein the controller cycles the cooling apparatus off when the first temperature sensor senses temperature associated with the beverage freezing.

8. The apparatus of claim 1 wherein the keg has a top portion through which the keg dispensing device extends into the keg.

9. The apparatus of claim 8 wherein the keg dispensing device comprises a hollow spear having a remote open end adjacent the bottom portion of the keg for drawing the beverage therethrough and out of the keg.

10. The apparatus of claim 1 wherein the cooling apparatus comprises a cooling plate in heat transfer relation with bottom portion of the keg for extracting heat therefrom and a Peltier thermoelectric device in heat transfer relation with the cooling plate for extracting heat from the cooling plate.

11. The apparatus of claim 1 further comprising insulated walls surrounding the keg.

12. The apparatus of claim 1 wherein the beverage is contained in a bag housed within the keg, and the keg dispensing device is connected to the bag and extends into the bag.

13. A beer or like alcohol beverage dispensing apparatus comprising:
a keg containing beer or like alcohol beverage and having a bottom portion;
a keg dispensing device extending into the keg to the bottom portion to draw the beverage from the keg adjacent the bottom portion;
a cooling apparatus in heat transfer contacting relation with the bottom portion of the keg for cooling the beverage contained in the keg through the bottom portion,
wherein the keg comprises a material selected from the group consisting of steel, stainless steel and copper that initially cools the beverage in the keg upwards from the bottom portion of the keg to produce a stratified beverage temperature effect whereby, prior to all the beverage in the keg reaching a desired serving temperature, the beverage adjacent the bottom portion of the keg is the coolest beverage available for an initial beverage serving.

14. The apparatus of claim 13 wherein the keg has a top portion through which the keg dispensing device extends into the keg.

15. The apparatus of claim 14 wherein the keg dispensing device comprises a hollow spear having a remote open end adjacent the bottom portion of the keg for drawing the beverage therethrough and out of the keg.

16. The apparatus of claim 13 wherein the cooling apparatus comprises a cooling plate in heat transfer relation with the bottom portion of the keg for extracting heat therefrom and a Peltier thermoelectric device in heat transfer relation with the cooling plate for extracting heat from the cooling plate.

17. The apparatus of claim 13 further comprising insulated walls surrounding the keg.

18. The apparatus of claim 17 wherein the insulated walls have graduated insulation with greater insulation capability adjacent the bottom portion of the keg and lessening insulation capability adjacent a top portion of the keg.

19. The apparatus of claim 13 wherein the beverage is contained in a bag housed within the keg, and the keg dispensing device is connected to the bag and extends into the bag.

20. A beer or like alcohol beverage dispensing apparatus comprising:
a keg containing beer or like alcohol beverage and having a bottom portion;
a keg dispensing device extending into the keg to the bottom portion to draw the beverage from the keg adjacent the bottom portion;
a cooling apparatus in heat transfer contacting relation with the bottom portion of the keg for cooling the beverage contained in the keg through the bottom portion,
wherein the keg comprises an aluminum material that initially cools the beverage in the container in substantially homogeneous manner above the bottom portion of the keg whereby two servings of beverage dispensed from the keg are at substantially the same temperature prior to the beverage reaching a desired serving temperature.

21. The apparatus of claim 20 wherein the keg has a top portion through which the keg dispensing device extends into the keg.

22. The apparatus of claim 21 wherein the keg dispensing device comprises a hollow spear having a remote open end adjacent the bottom portion of the keg for drawing the beverage therethrough and out of the keg.

23. The apparatus of claim 20 wherein the cooling apparatus comprises a cooling plate in heat transfer relation with the bottom portion of the keg for extracting heat therefrom and a Peltier thermoelectric device in heat transfer relation with the cooling plate for extracting heat from the cooling plate.

24. The apparatus of claim 20 further comprising insulated walls surrounding the keg.

25. The apparatus of claim 20 wherein the beverage is contained in a bag housed within the keg and the keg dispensing device is connected to the bag and extends into the bag.

26. The apparatus of claim 20 wherein the keg has side walls extending up from the bottom portion and the cooling apparatus is adapted to extend up at least a portion of these side walls in heat exchange relation therewith.

27. A beer or like alcohol beverage dispensing apparatus comprising:
a keg containing beer or like alcohol beverage and having a bottom portion;
a keg dispensing device extending into the keg to the bottom portion to draw the beverage from the keg adjacent the bottom portion;
a cooling apparatus in heat transfer contacting relation with the bottom portion of the keg for cooling the beverage contained in the keg through the bottom portion, which cooling apparatus comprises:
a first temperature sensor mounted in heat sensing relation with a bottom portion of the keg to sense first temperatures related to temperature of the beverage at the bottom portion of the keg;
a second temperature sensor mounted in heat sensing relation with an upper portion of the keg to sense second temperatures related to temperature of the beverage at the upper portion of the keg; and,
a cooling controller responsive to the first and second temperature sensors for controlling operation of the cooling apparatus to extract heat from the bottom portion of the keg to lower and maintain temperature of the beverage contained in the keg at a desired beverage serving temperature.
wherein the keg comprises a material selected from the group consisting of steel, stainless steel, aluminum and copper that initially cools the beverage in the keg upwards from the bottom portion of the keg and the beverage adjacent the bottom portion of the keg is the coolest beverage available for an initial beverage serving.

28. The apparatus of claim 27 wherein the keg has a top portion through which the keg dispensing device extends into the keg.

29. The apparatus of claim 28 wherein the keg dispensing device comprises a hollow spear having a remote open end adjacent the bottom portion of the keg for drawing the beverage therethrough and out of the keg.

30. The apparatus of claim 27 wherein the cooling apparatus comprises a cooling plate in heat transfer relation with the bottom portion of the keg for extracting heat therefrom and a Peltier thermoelectric device in heat transfer relation with the cooling plate for extracting heat from the cooling plate.

31. The apparatus of claim 27 further comprising insulated walls surrounding the keg.

32. The apparatus of claim 31 wherein the insulated walls have graduated insulation with greater insulation capability adjacent the bottom portion of the keg and lessening insulation capability adjacent a top portion of the keg.

33. The apparatus of claim 27 wherein the beverage is contained in a bag housed within the keg, and the keg dispensing device is connected to the bag and extends into the bag.

34. A beer or like alcohol beverage dispensing apparatus comprising:
a keg containing beer or like alcohol beverage and having a bottom portion;
a keg dispensing device extending into the keg to the bottom portion to draw the beverage from the keg adjacent the bottom portion;
a cooling apparatus in heat transfer contacting relation with the bottom portion of the keg for cooling the beverage contained in the keg through the bottom portion,
wherein the keg comprises an aluminum material that initially cools the beverage in the container in substantially homogeneous manner above the bottom portion of the keg whereby two servings of beverage dispensed from the keg are at, substantially the same temperature prior to the beverage reaching a desired serving temperature.

35. The apparatus of claim 34 wherein the keg has a top portion through which the keg dispensing device extends into the keg.

36. The apparatus of claim 35 wherein the keg dispensing device comprises a hollow spear having a remote open end adjacent the bottom portion of the keg for drawing the beverage therethrough and out of the keg.

37. The apparatus of claim 34 wherein the cooling apparatus comprises a cooling plate in heat transfer relation with the bottom portion of the keg for extracting heat therefrom and a Peltier thermoelectric device in heat transfer relation with the cooling plate for extracting heat from the cooling plate.

38. The apparatus of claim 34 further comprising insulated walls surrounding the keg.

39. The apparatus of claim 34 wherein the beverage is contained in a bag housed within the keg and the keg dispensing device is connected to the bag and extends into the bag.

40. The apparatus of claim 34 wherein the keg has side walls extending up from the bottom portion and the cooling apparatus is adapted to extend up at least a portion of these side walls in heat exchange relation therewith.

41. A keg for containing beer or like alcohol beverage and having a bottom portion in combination with a keg dispensing device which extends into the keg to the bottom portion to draw the beverage from the keg adjacent the bottom portion and wherein the keg comprises a material selected from the group consisting of steel, stainless steel and copper that is adapted to allow initial cooling of the beverage in the keg upwards from the bottom portion of the keg to produce a stratified beverage temperature effect whereby, prior to all the beverage in the keg reaching a desired serving temperature, the beverage adjacent the bottom portion of the keg is the coolest beverage available for an initial beverage serving.

42. A keg containing beer or like alcohol beverage and having a bottom portion; a keg dispensing device extending into the keg to the bottom portion to draw the beverage from the keg adjacent the bottom portion, wherein the keg comprises an aluminum material that is adapted allow to initial cooling of the beverage in the container in substantially homogeneous manner above the bottom portion of the keg whereby two servings of beverage dispensed from the keg are at substantially the same temperature prior to the beverage reaching a desired serving temperature.

43. The apparatus of claim 41 or 42 wherein the keg has a top portion through which the keg dispensing device extends into the keg, the keg dispensing device comprising a hollow spear having a remote open end adjacent the bottom portion of the keg for drawing the beverage therethrough and out of the keg.

44. The keg of claim 27 or 28 wherein the beverage is contained in a bag housed within the keg and the keg dispensing device is connected to the bag and extends into the bag.

45. The keg of claim 27 or 28 wherein the bottom portion of the keg is adapted to be in mechanical and heat transfer contacting relation with an associated cooling plate.

46. A keg for containing beer or like alcohol beverage and having a bottom portion in combination with a keg dispensing device which extends into the keg to the bottom portion to draw the beverage from the keg adjacent the bottom portion and wherein the keg comprises a material selected from the group consisting of steel, stainless steel, aluminum and copper to allow initial cooling of the beverage in the keg upwards from the bottom portion of the keg and the beverage adjacent the bottom portion of the keg to be the coolest beverage available for an initial beverage serving.

47. The keg of claim 46 wherein the keg dispensing device comprises a hollow spear having a remote open end adjacent the bottom portion of the keg for drawing the beverage therethrough and out of the keg.

48. The keg of claim 47 which further includes:
a first temperature sensor mounted in heat sensing relation with a bottom portion of the keg to sense first temperatures related to temperature of a beverage at the bottom portion of the keg;
a second temperature sensor mounted in heat sensing relation with an upper portion of the keg to sense second temperatures related to temperature of a beverage at the upper portion of the keg.

49. The keg of claim 46 wherein a beverage is contained in a bag housed within the keg and the keg dispensing device is connected to and extends into the bag.
